(19) United States
(12) Patent Application Publication
(10) Pub. No.: US 2024/0171020 A1
(43) Pub. Date: May 23, 2024

(54) STATOR HAVING COOLING FLOW PATH AND MOTOR INCLUDING THE SAME

(71) Applicant: HYUNDAI MOBIS CO., LTD., Seoul (KR)

(72) Inventor: Goon Chul KIM, Yongin-si (KR)

(73) Assignee: HYUNDAI MOBIS CO., LTD., Seoul (KR)

(21) Appl. No.: 18/379,300

(22) Filed: Oct. 12, 2023

(30) Foreign Application Priority Data
Nov. 21, 2022 (KR) 10-2022-0156106

(51) Int. Cl. H02K 1/20; H02K 9/19

(52) U.S. Cl. CPC H02K 1/20; H02K 9/19

(57) ABSTRACT

A stator comprises: a core including a yoke having an annular, a teeth extending inwardly from the yoke and radially disposed, and a shoe disposed at an end of each tooth, and a cooling flow path disposed inside the core, at least one cooling fluid inlet is disposed along an outer circumferential surface of the core, and at least one cooling fluid outlet connected to the at least one cooling fluid inlet is disposed in the yoke or the teeth in an upper surface of the core.

### CROSS-REFERENCE TO RELATED APPLICATIONS

This application claims priority under 35 U.S.C. § 119 to Korean Patent Application No. 10-2022-0156106, filed on Nov. 21, 2022, in the Korean Intellectual Property Office, the disclosure of which is incorporated herein by reference in its entirety.

### TECHNICAL FIELD

The following disclosure relates to a stator having a cooling flow path and a motor including the stator, and in particular, to a motor having a simple structure, while having cooling efficiency similar to that of the related art or improved cooling efficiency.

### BACKGROUND

Motors are energy conversion devices converting electrical energy into magnetic energy and magnetic energy into mechanical energy. Energy conversion loss occurs in each energy conversion process, and the loss appears in the form of heat and sound. Heat in motors increases resistance of a coil to which current is applied, and in the case of a motor using a permanent magnet, heat slows down magnetic flux density of the permanent magnet, which eventually degrades power. In addition, heat generated from motors not only deteriorates insulation performance of the motors by affecting corrosion or insulation performance of insulators, but also shortens lifespan, and thus, an appropriate cooling structure has to be applied to motors to prevent such problems.

In the related art motor, a flow path is disposed on an outer circumferential surface of the core to effectively cool heat generated by the motor. This structure requires a cooling guide, a separate structure allowing cooling oil discharged along the outer circumferential surface of the core to be directly sprayed to a coil, but this method lowers assembly and economic efficiency and increases the volume of the motor in that the separate structure is required.

### RELATED ART DOCUMENT

### Patent Document

Korean Application Publication No. 10-2022-0127556 (Motor and motor cooling system, published on Sep. 20, 2022)

### SUMMARY

An embodiment of the present invention is directed to providing a stator having a cooling flow path of a simple structure and a motor including the same, capable of directly spraying cooling oil to a coil included in a motor even without a cooling guide, thereby improving assemblability and economic efficiency and reducing the size of the motor.

In one general aspect, a stator includes: a core including an annular yoke, a plurality of radially disposed teeth extending inwardly from the yoke, and a shoe disposed at an end of the tooth; and a cooling flow path disposed inside the core, wherein at least one inlet of cooling fluid is disposed along an outer circumferential surface of the core, and at least one outlet of cooling fluid connected to the at least one cooling fluid inlet is disposed in the yoke or the tooth portion in an upper surface of the core.

An outer flow path recessed in an annular shape, through which cooling fluid is injected and circulated, may be disposed in a portion of the outer circumferential surface of the core in which the inlet is disposed.

The stator may further include: a partition disposed in the outer flow path to block a portion of the outer flow path and limiting a flow direction of the cooling fluid in the outer flow path.

The core may include two first parts and a second part disposed between the first parts, the first part may be disposed by stacking a plurality of first steel plates in which holes are disposed at positions corresponding to the outlet, the second part may have a groove disposed in a position corresponding to the inlet and may be disposed by stacking a plurality of second steel plates having a diameter less than a diameter of the first steel plate, and the groove may be disposed from a position corresponding to the outlet to a position corresponding to the outer circumferential surface of the core.

The core may include two first parts and a second part disposed between the first parts, the first part may be disposed by stacking a plurality of first steel plates in which holes are disposed at positions corresponding to the outlet, the second part may have a groove formed in a position corresponding to the inlet and is disposed by stacking a plurality of second steel plates having a diameter less than a diameter of the first steel plate, a portion of an outer surface of the second steel plate corresponding to the partition may protrude, and the groove may be disposed from a position corresponding to the outlet to a position corresponding to the outer circumferential surface of the core.

The tooth may have a width decreasing inwardly, and a width of a portion in which the outlet is disposed may be equal to or greater than a sum of the width of the outlet and the width of an inner end of the tooth.

In another general aspect, a motor includes: the stator; a housing having an injection port for cooling fluid connected to the outer flow path disposed on the outer circumferential surface of the core of the stator; and a cooling unit injecting cooling fluid into the injection port.

The stator may include a partition disposed in the outer flow path to limit a flow direction of cooling water in the outer flow path, wherein the partition may be disposed in a position adjacent to the injection port in the outer flow path.

The housing may further include: a main flow path to which the injection port and the cooling unit are connected; and an auxiliary injection port branched from the main flow path and connected to the outer flow path between the partition and the injection port, among both ends of the injection port.

The stator may include a partition disposed in the outer flow path to limit a flow direction of cooling water in the outer flow path, a plurality of partitions may be disposed in positions spaced apart from each other by a predetermined distance to divide the outer flow path into a plurality of flow paths, and the injection port may be disposed in a number corresponding to the number of the partitions, and the injection ports are disposed in positions adjacent to the partitions, respectively.

n partitions may be disposed in the outer flow path, and an angle between two adjacent partitions may be 360/n degrees.

Other features and aspects will be apparent from the following detailed description, the drawings, and the claims.

### BRIEF DESCRIPTION OF THE DRAWINGS

FIG. 1 is a perspective view of a stator according to an embodiment of the present invention;

FIG. 2 is a cross-sectional view of a stator showing flow of a cooling fluid in a stator according to an embodiment of the present invention;

FIG. 3 is an exploded perspective view of a stator according to an embodiment of the present invention;

FIG. 4 is a plan view of a first steel plate of a stator according to an embodiment of the present invention;

FIG. 5 is a plan view of a second steel plate of a stator according to an embodiment of the present invention;

FIG. 6 is a comparison of diameters of a first steel plate and a second steel plate of a stator according to an embodiment of the present invention;

FIG. 7 is a partially enlarged view of FIG. 4;

FIG. 8 is a schematic cross-sectional view of a motor according to an embodiment of the present invention; and

FIG. 9 is a schematic cross-sectional view of a motor according to another embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The specific structures and functional description will be only provided for the purpose of illustration of the embodiments according to the concept of the invention, so that the embodiments of the invention may be embodied in many different forms and should not be construed as being limited to the embodiments set forth herein. The embodiments according to the concept of the invention may be changed to diverse forms, so that the invention will be described and illustrated with reference to specific embodiments. However, it should be understood that the embodiments according to the concept of the invention are not intended to limit to the specific embodiments disclosed, but they include all the modifications, equivalences, and substitutions, which are included in the scope and sprint of the invention. It will be understood that although the terms “first,” and/or “second,” etc. may be used herein to describe various elements, these elements should not be limited by these terms. These terms are only used to distinguish one element from another element. Thus, a first element discussed below could be termed a second element and vice versa without departing from the nature of the present invention. It will be understood that when an element is referred to as being “connected or coupled” to another element, it may be directly connected or coupled to the other element or intervening elements may be present therebetween. In contrast, when an element is referred to as being “directly connected or coupled” to another element, there are no intervening elements present. Other expressions, such as “between” and “directly between,” or “adjacent” or “directly adjacent” should be understood in a similar manner. The terminology used herein is for the purpose of describing particular embodiments only and is not intended to limit the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof. Unless otherwise defined, the meaning of all terms including technical and scientific terms used herein is the same as that commonly understood by one of ordinary skill in the art to which the present invention belongs. It will be further understood that terms, such as those defined in commonly used dictionaries, should be interpreted as having a meaning which is consistent with their meaning in the context of the relevant art and the present invention, and will not be interpreted in an idealized or overly formal sense unless expressly so defined herein. The invention will now be described with reference to the accompanying drawings, in which embodiments of the invention are shown. The same reference numerals indicated in the drawings refer to similar elements throughout.

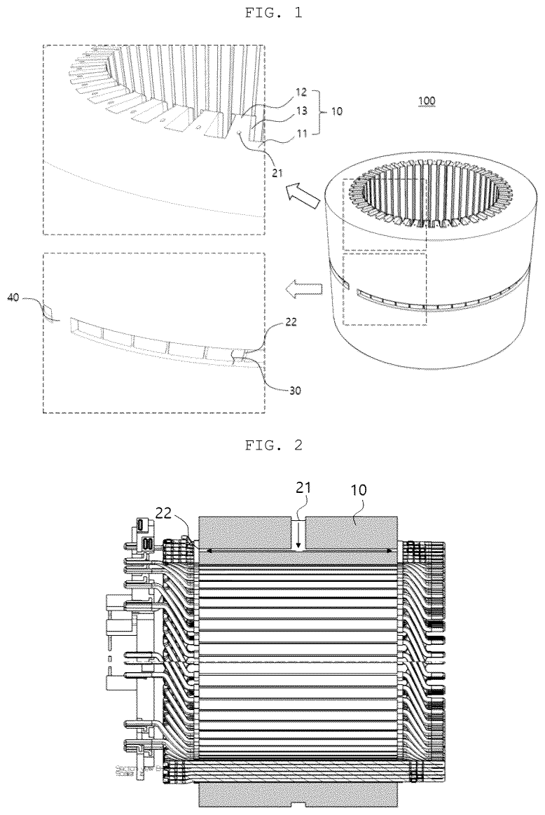

FIG. 1 is a perspective view of a stator according to an embodiment of the present invention.

A stator 100 according to an embodiment of the present invention is a stator applied to a motor and may include a core 10 and a cooling flow path (not shown).

As shown in FIG. 1, a core 10 is a portion constituting an exterior of the stator 100 according to an embodiment of the present invention, and includes a yoke 11, a tooth 12, and a shoe 13.

The yoke 11 is a kind of tubular shape having an annular cross section. The tooth 12 extends inwardly from an inner circumferential surface of the yoke 11, and the shoe 13 is a portion widening from an inner end of the tooth 12. Although not shown in the drawing, in the motor to which the stator according to the present invention is applied, a coil is wound around the tooth 12.

The cooling flow path is a kind of flow path disposed inside the core 10. A cooling fluid flows in the cooling flow path. An inlet 22 and an outlet 21 may be disposed in the core 10. The cooling fluid used in the motor may largely include cooling water and cooling oil, and the cooling fluid used in the present invention may be cooling oil.

As shown in FIG. 1, a plurality of inlets 22 may be disposed along an outer circumferential surface of the core 10, and the outlet 21 may be disposed on an upper surface of the tooth 12 included in the core 10. However, in the present invention, a position in which the outlet 21 is disposed is not limited to the tooth 12, and the outlet 21 may be disposed in a portion of the yoke 11 adjacent to the tooth 12 in some cases.

On an outer circumferential surface of the core 10, an outer flow path 30 is disposed in an annular shape and is more recessed than other portions. The inlet 22 of the cooling flow path described above may be disposed in the outer flow path 30. In the motor to which the present invention is applied, the cooling unit injects the cooling fluid toward the inlet 22 through the outer flow path 30. The cooling fluid injected through the inlet 22 flows along the cooling flow path disposed inside the core 10 and is discharged through the outlet 21. In the motor to which the present invention is applied, a coil is disposed on one side of the outlet 21. Therefore, the cooling fluid discharged through the outlet 21 may be directly sprayed to the coil to contact the coil to directly cool the coil. According to the present invention, the cooling flow path may be disposed inside the core 10 and the cooling fluid may be sprayed toward the coil without using a separate cooling guide by adjusting a position of the outlet 21, thereby implementing a motor including a simpler cooling structure. In addition, compared to the related art motor in which a flow path is disposed on the outer circumferential surface of the core, since the cooling flow path is located inside the core, an outer diameter of the core 10 may be reduced by the size of the flow path applied to the outer circumferential surface of the related art, thereby reducing costs and the size of the motor. In addition, a cooling portion may be easily adjusted using a method of adjusting the position of the outlet 21 during design.

Although not shown in FIG. 1, the cooling flow path disposed inside the core 10 may extend to a certain extent in a direction perpendicular to the surface in which the inlet 22 is disposed, that is, in a direction of a rotational axis of the core 10, and then be bent toward the outlet 21 from the portion in which the outlet 21 is located. That is, the cooling flow path disposed inside the core 10 may have an L-shape connecting the inlet 22 to the outlet 21. However, in the present invention, the cooling flow path is not limited to the L-shape, and in an embodiment, the portion of the cooling flow path which is bent in the L-shape may be bent in a diagonal direction or may be disposed in a curved shape to reduce flow resistance of the cooling fluid in the cooling flow path disposed inside the core 10.

As shown in FIG. 1, the stator according to an embodiment of the present invention may further include a partition 40 disposed in the outer flow path 30.

The partition 40 is disposed in the outer flow path 30 to block a portion of the outer flow path 30 and restricts a flow direction of the cooling fluid flowing through the outer flow path 30. A plurality of partitions 40 may be disposed as needed, but only a single partition may be disposed in the stator according to an embodiment of the present invention. A process of restricting a specific flow direction of the cooling fluid due to the partition 40 will be described below.

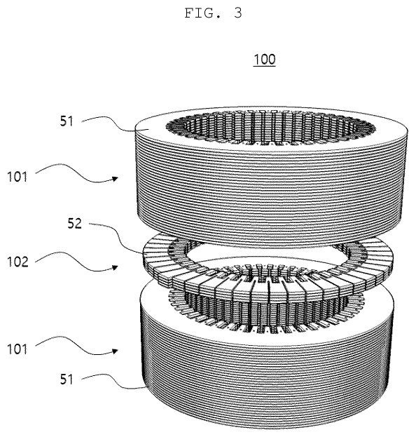

FIG. 2 is a cross-sectional view of a stator showing flow of a cooling fluid in a stator according to an embodiment of the present invention.

As shown in FIG. 2, the cooling fluid injected through the inlet 22 is discharged toward the coil from the outlet 21 to cool the coil.

FIG. 3 is an exploded perspective view of a stator according to an embodiment of the present invention.

As shown in FIG. 3, the stator 100 according to an embodiment of the present invention may include two first parts 101 and a second part 102 located between two first parts 101.

The first part 101 and the second part 102 may be disposed by stacking a plurality of steel plates, like a method of forming a stator of a general motor, and a steel plate constituting the first part 101 is referred to as a first steel plate 51, and a steel plate constituting the second part 102 is referred to as a second steel plate 52.

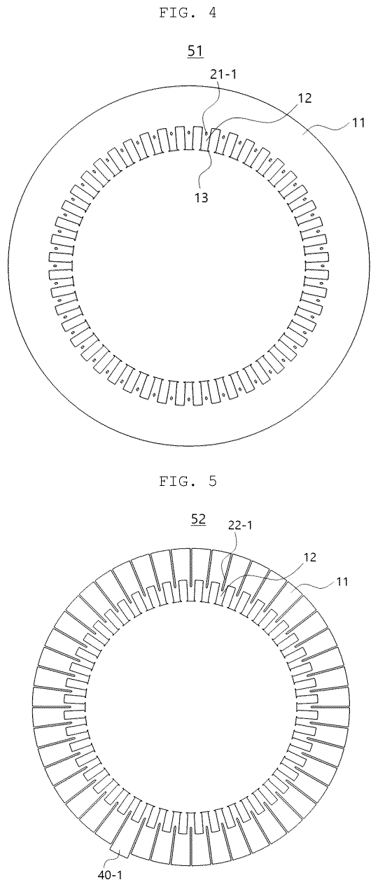

FIG. 4 is a plan view of a first steel plate of a stator according to an embodiment of the present invention.

As shown in FIG. 4, a first steel plate 51 of the stator according to an embodiment of the present invention forms a portion except for a portion in which the outer flow path 30 is disposed. The first steel plate 51 may include the yoke 11, the tooth 12, and the shoe 13 of the core 10 described above, and a hole 21-1 is disposed in a position corresponding to the outlet 21. That is, a portion of the cooling flow path connected to the outlet 21 may be disposed through the hole 21-1 of the first steel plates 51 stacked in one direction.

FIG. 5 is a plan view of a second steel plate of a stator according to an embodiment of the present invention.

As shown in FIG. 5, a second steel plate 52 of the stator according to an embodiment of the present invention forms a portion in which the outer flow path 30 is disposed. The second steel plate 52 also includes the yoke 11, the tooth 12, and the shoe 13, and a groove 22-1 is disposed in a position corresponding to the inlet 22. The groove 22-1 is disposed to extend from a position corresponding to the hole 21-1 to an outer circumferential surface of the second steel plate 52 in a radial direction. That is, when the first steel plate 51 and the second steel plate 52 are stacked on top of each other, an inner end portion of the groove 22-1 overlaps the hole 21-1, and a flow path disposed by the groove 22-1 and a flow path disposed by the hole 21-1 are connected to each other to form a cooling flow path.

As shown in FIG. 5, a portion of the outer circumferential surface of the second steel plate 52 protrudes outwardly, which is referred to as a protrusion 40-1. The protrusion 40-1 is disposed in a position corresponding to the partition 40, and when a plurality of second steel plates 52 are stacked, the stacked protrusions 40-1 form the partition 40.

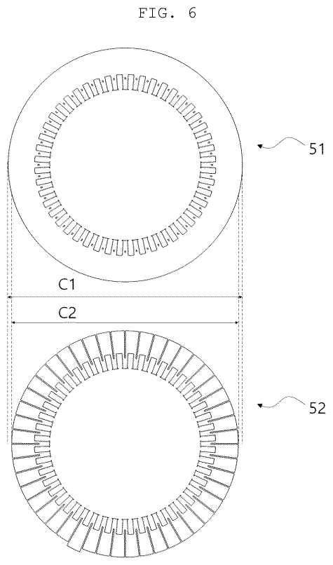

FIG. 6 shows comparison of diameters of the first steel plate 51 and the second steel plate 52 of the stator according to an embodiment of the present invention.

As shown in FIG. 6, a diameter C1 of the first steel plate 51 is greater than a diameter C2 of the second steel plate 52. This is because the second steel plate 52 has the outer flow path 30 disposed to be recessed in an annular shape on the outer circumferential surface of the core 10. That is, through a difference between the diameters of the first steel plate 51 and the second steel plate 52, the outer flow path 30 is disposed by two facing surfaces of the first part 101 spaced apart from each other by a certain distance and the outer circumferential surface of the second steel plate 52.

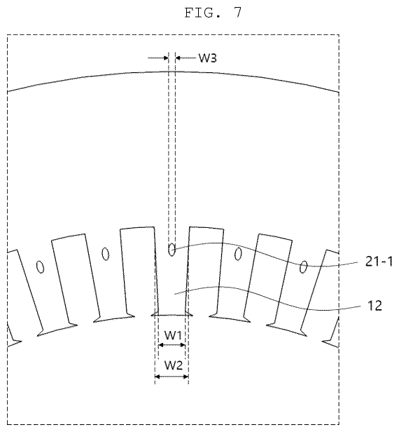

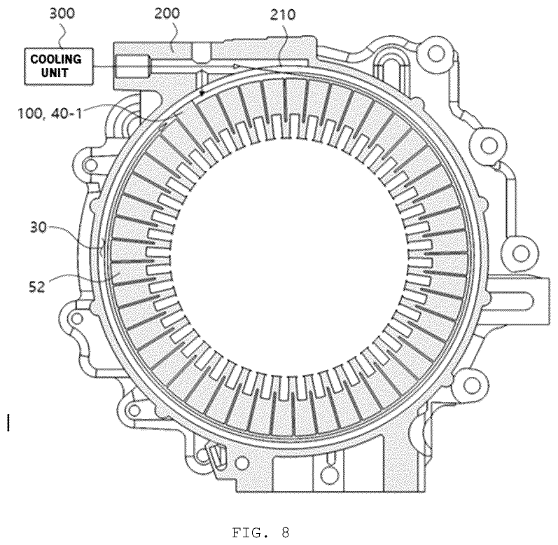

FIG. 7 is a partially enlarged view of FIG. 4.

As shown in FIG. 7, the tooth 12 may have a width decreasing inwardly. In this case, a width W1 of a portion in which the hole 21-1 is disposed may be a value equal to or greater than the sum of W2, a width of an inner end of the tooth 12, and W3, a width of the hole 21-1 constituting the cooling flow path in W2. This is to limit the shape including the width of the tooth 12 in order to prevent saturation of magnetic flux density of the core 10.

FIG. 8 is a schematic cross-sectional view of a motor according to an embodiment of the present invention.

As shown in FIG. 8, a motor according to an embodiment of the present invention includes the stator 100, the housing 200, and the cooling unit 300 described above.

In FIG. 8, since the stator 100 is shown in cross-section, the second steel plate 52 is shown. As shown in FIG. 8, the housing 200 accommodates the stator 100 and has an injection port 210 connected to the outer flow path 30 disposed on the outer circumferential surface of the core 10 of the stator 100.

The cooling unit 300 is a device for injecting a cooling fluid into the injection port 210 and may include a device capable of moving fluid, such as a pump. The cooling fluid injected from the cooling unit 300 into the injection port 210 moves along the outer flow path 30. While moving along the outer flow path 30, the cooling fluid passes along the cooling flow path through the inlet 22 connected to the outer flow path 30 and is discharged to the outlet 21. The partition 40 is disposed in the outer flow path 30 to restrict flow of the cooling fluid and induce the cooling fluid injected into the outer flow path 30 to flow to the cooling flow path through the inlet 22.

The partition 40 may be located to be adjacent to the injection port 210, and more specifically, an angle between an end portion of the injection port 210 adjacent to the partition 40, among both ends of the injection port 210, and the partition 40 may be determined as angles between 0 to 10 degrees. This is to allow the cooling fluid injected through the injection port 210 to be injected into all the inlets 22 disposed in the core 10, thereby increasing cooling efficiency of the motor according to the present invention. However, even if the partition 40 is disposed to be adjacent to the injection port 210 according to design, there may be a region to which the cooling fluid is not immediately supplied between the partition 40 and the injection port 210. To this end, the housing 200 may further include an auxiliary injection port 220 branched from a main flow path connected to the injection port and connected to the outer flow path 30 between the partition 40 and the injection port 210, so that the cooling fluid may be immediately injected into a portion not covered by the injection port 210 through the auxiliary injection port 220.

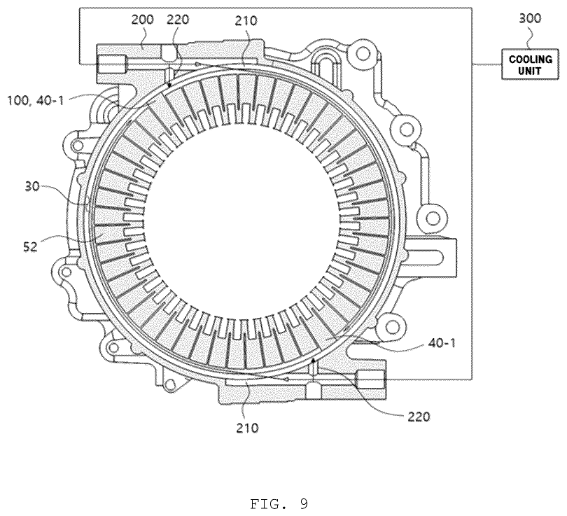

FIG. 9 is a schematic cross-sectional view of a motor according to another embodiment of the present invention.

As shown in FIG. 9, in a motor according to another embodiment of the present invention, two partitions 40 are disposed on the outer flow path 30, and two injection ports 210 are disposed in a position corresponding to the partition 40 on the housing 200. However, in the motor according to the present invention, the number of partitions 40 and injection ports 210 is not limited to two, and the number of partitions 40 and injection ports 210 may be three or more.

As shown in FIG. 9, the partitions 40 are spaced apart from each other by a predetermined distance. More specifically, an angle between two partitions 40 disposed on the outer flow path 30 is 180 degrees, and two partitions 40 are located farthest from each other based on the circumference of the outer flow path 30. This is because the lengths of the outer flow path 30 divided by the partition 40 are the same only when two partitions 40 are located farthest from each other, so that a cooling target becomes uniform by the cooling fluid and the cooling efficiency increases. Two injection ports 210 may also be located to be adjacent to two partitions 40, respectively.

Also, as shown in FIG. 9, the cooling unit 300 may be configured to supply cooling fluid to each of two injection ports 210.

As described above, according to the stator having a cooling flow path and the motor including the same according to various embodiments of the present invention, the flow path, which is disposed on the outer circumferential surface of the related art core, is disposed inside the core, and the flow path is located in a position in which magnetic flux is not saturated, and thus, the outer diameter may be reduced, compared to the related art core.

In addition, according to the present invention, compared to the related art, there is no need for a cooling guide, which is a separate structure, and thus assemblability and economic efficiency may be improved.

In addition, according to the present invention, the position of the cooling flow path may be changed by changing the position of the hole during design, if necessary, so that the cooling portion may be easily adjusted.

Although the embodiments of the present invention have been described above, the embodiments disclosed in the present invention are not intended to limit the technical spirit of the present invention, but are only for explanation. Therefore, the technical spirit of the present invention includes not only each disclosed embodiment, but also a combination of the disclosed embodiments, and furthermore, the scope of the technical spirit of the present invention is not limited by these embodiments. In addition, those skilled in the art to which the present invention pertains may make many changes and modifications to the present invention without departing from the spirit and scope of the appended claims, and all such appropriate changes and modifications are to be regarded as equivalents falling within the scope of the present invention.

What is claimed is:

1. A stator comprising:
a core including a yoke having an annular shape, a teeth extending inwardly from the yoke and radially disposed, and a shoe disposed at an end of each tooth; and
a cooling flow path disposed inside the core, wherein at least one cooling fluid inlet is disposed along an outer circumferential surface of the core, and at least one cooling fluid outlet connected to the at least one cooling fluid inlet is disposed in the yoke or the teeth in an upper surface of the core.

2. The stator of claim 1, wherein an outer flow path recessed in the annular shape, through which cooling fluid is injected and circulated, is disposed in a portion of the outer circumferential surface of the core in which the at least one cooling fluid inlet is disposed.

3. The stator of claim 2, further comprising:
a partition disposed in the outer flow path to block a portion of the outer flow path and limiting a flow direction of the cooling fluid in the outer flow path.

4. The stator of claim 1, wherein
the core includes two first parts and a second part disposed between the two first parts,
each of two first parts is disposed by stacking a plurality of first steel plates in which holes are disposed at positions corresponding to the at least one cooling fluid outlet,
the second part has a groove disposed in a position corresponding to the at least one cooling fluid inlet and is disposed by stacking a plurality of second steel plates having a diameter less than a diameter of the first steel plate, and
the groove is disposed from a position corresponding to the at least one cooling fluid outlet to a position corresponding to the outer circumferential surface of the core.

5. The stator of claim 3, wherein
the core includes two first parts and a second part disposed between the first parts,
each of the two first parts is disposed by stacking a plurality of first steel plates in which holes are disposed at positions corresponding to the at least one cooling fluid outlet,
the second part has a groove disposed in a position corresponding to the at least one cooling fluid inlet and is disposed by stacking a plurality of second steel plates having a diameter less than a diameter of the first steel plate,
a portion of an outer surface of the second steel plate corresponding to the partition protrudes, and
the groove is disposed from a position corresponding to the at least one cooling fluid outlet to a position corresponding to the outer circumferential surface of the core.

6. The stator of claim 1, wherein
each tooth has a width decreasing inwardly, and
a width of a portion in which the at least one cooling fluid outlet is disposed is equal to or greater than a sum of the width of the at least one cooling fluid outlet and the width of an inner end of the tooth.

7. A motor comprising:
a stator including:
a core including a yoke having an annular shape, a teeth extending inwardly from the yoke and radially disposed, and a shoe disposed at an end of each tooth; and
a cooling flow path disposed inside the core, wherein at least one cooling fluid inlet is disposed along an outer circumferential surface of the core, and at least one cooling fluid outlet connected to the at least one cooling fluid inlet is disposed in the yoke or the teeth in an upper surface of the core;
a housing having an injection port for cooling fluid connected to an outer flow path disposed on the outer circumferential surface of the core of the stator; and
a cooling unit configured to inject the cooling fluid into the injection port.

8. The motor of claim 7, wherein
the stator includes a partition disposed in the outer flow path to limit a flow direction of cooling water in the outer flow path,
wherein the partition is disposed in a position adjacent to the injection port in the outer flow path.

9. The motor of claim 8, wherein
the housing further includes:
a main flow path to which the injection port and the cooling unit are connected; and
an auxiliary injection port branched from the main flow path and connected to an outer flow path between the partition and the injection port, among both ends of the injection port.

10. The motor of claim 7 wherein
the stator includes a partition disposed in the outer flow path to limit a flow direction of cooling water in the outer flow path,
the partition is disposed in a a plurality of partitions,
the plurality of partitions are disposed in positions spaced apart from each other by a predetermined distance to divide the outer flow path into a plurality of flow paths, and
the injection port is disposed in a number of injection ports corresponding to the number of the plurality of partitions, and each of the injection ports is disposed in positions adjacent to each of the plurality of partitions, respectively.

11. The motor of claim 10, wherein
an angle between two adjacent partitions of the plurality of partitions is 360/n degrees, wherein the n represents the number of the plurality of partitions.

12. The motor of claim 7, wherein an outer flow path recessed in the annular shape, through which cooling fluid is injected and circulated, is disposed in a portion of the outer circumferential surface of the core in which the at least one cooling fluid inlet is disposed.

13. The motor of claim 7, wherein:
the core includes two first parts and a second part disposed between the two first parts,
each of two first parts is disposed by stacking a plurality of first steel plates in which holes are disposed at positions corresponding to the at least one cooling fluid outlet,
the second part has a groove disposed in a position corresponding to the at least one cooling fluid inlet and is disposed by stacking a plurality of second steel plates having a diameter less than a diameter of the first steel plate, and
the groove is disposed from a position corresponding to the at least one cooling fluid outlet to a position corresponding to the outer circumferential surface of the core.

14. The motor of claim 8, wherein:
the core includes two first parts and a second part disposed between the first parts,
each of the two first parts is disposed by stacking a plurality of first steel plates in which holes are disposed at positions corresponding to the at least one cooling fluid outlet,
the second part has a groove disposed in a position corresponding to the at least one cooling fluid inlet and is disposed by stacking a plurality of second steel plates having a diameter less than a diameter of the first steel plate,
a portion of an outer surface of the second steel plate corresponding to the partition protrudes, and
the groove is disposed from a position corresponding to the at least one cooling fluid outlet to a position corresponding to the outer circumferential surface of the core.

15. The motor of claim 7, wherein
each tooth has a width decreasing inwardly, and
a width of a portion in which the at least one cooling fluid outlet is disposed is equal to or greater than a sum of the width of the at least one cooling fluid outlet and the width of an inner end of the tooth.
